(19) United States
(12) Patent Application Publication
(10) Pub. No.: US 2021/0324678 A1
(43) Pub. Date: Oct. 21, 2021

(54) BARRIER LAYER FOR AN ARCHITECTURAL-STRUCTURE COVERING

(71) Applicant: Hunter Douglas, Inc., Pearl River, NY (US)

(72) Inventors: Joseph E. Kovach, Broomfield, CO (US); James M. Anthony, Denver, CO (US)

(73) Assignee: Hunter Douglas, Inc., Pearl River, NY (US)

(21) Appl. No.: 17/209,433

(22) Filed: Mar. 23, 2021

Related U.S. Application Data
(60) Provisional application No. 63/010,983, filed on Apr. 16, 2020.

(51) Int. Cl. E06B 9/262; E06B 9/384

(52) U.S. Cl. CPC E06B 9/262; E06B 2009/2627; E06B 9/384

(57) ABSTRACT

An architectural-structure covering and corresponding method of manufacturing, assembly, or the like is disclosed. The architectural-structure covering including a covering comprising a front layer, a rear layer, and an intermediate barrier layer, wherein the intermediate barrier layer is coupled to a rear side of the front layer and to a front side of the rear layer so that the intermediate barrier layer is positioned between the front and rear layers. The architectural-structure covering further comprising a plurality of lift elements arranged and configured to move the covering between extended and retracted positions. The lift elements being positioned being the intermediate and rear layers. In this manner, the lift elements may be sandwiched between the intermediate and rear layers thus rending the lift elements inaccessible, or at least greatly limiting accessibility, to an end user.

### CROSS-REFERENCE TO RELATED APPLICATIONS

This application makes reference to and claims the benefit of the filing date of pending U.S. provisional patent application No. 63/010,983, filed Apr. 16, 2020, entitled “A Barrier Layer for an Architectural-Structure Covering,” which application is incorporated by reference herein in its entirety.

### FIELD OF THE DISCLOSURE

The present disclosure relates generally to the field of architectural-structure coverings, and more particularly to a barrier layer, a shroud, a sheet, or the like for an architectural-structure covering to prevent access to lift elements, and corresponding methods of manufacturing.

### BACKGROUND

Architectural-structure coverings may selectively cover an architectural structure such as, for example, a window, a doorway, a skylight, a hallway, an archway, a portion of a wall, etc. (collectively an architectural structure without the intent to limit). Generally speaking, architectural-structure coverings may include a covering that can be extendable and retractable, for example, vertically extendable or retractable (e.g., able to be lowered or raised, respectively, in a vertical direction) between an extended position and a retracted position for obscuring and exposing the underlying architectural structure. The architectural-structure covering may further include a bottom rail attached to a lower edge of the covering. The bottom rail may be utilized to add weight along the lower edge of the covering to encourage the covering to drop by gravity during deployment.

To move the covering between the extended and retracted positions, some architectural-structure coverings include a rotatable member (e.g., a rod or a roller) positionable, for example, in a head rail. In use, rotation of the rotatable member in a first direction may retract the covering while rotation of the rotatable member in a second, opposite direction may extend the covering. The covering of the architectural-structure covering may be gathered or stacked adjacent to, or wrapped around, the rotatable member. For example, some retractable coverings include a plurality of cells that are raised or lowered as lift elements, such as lift cords, lift straps, or any other suitable element or mechanism for raising and lowering the covering, are wrapped about or unwrapped from the rotatable member. The architectural-structure covering may include lift elements which are coupled to the rotatable member and the covering such as, for example, the bottom rail. In use, rotation of the rotatable member in a first direction wraps the lift elements about the rotatable member causing the covering to retract adjacent to the rotatable member while rotation in a second direction causes the lift elements to unwrap about the rotatable member causing the covering to move to an extended position. Alternatively, in various embodiment, the covering may be wrapped around the rotatable member in the retracted position. For example, some retractable coverings include a flexible covering suspended from the rotatable member. The covering can either be wrapped about the rotatable member to retract the covering or unwrapped from the rotatable member to extend the covering. Regardless of the form of the retractable covering, rotation of the rotatable member generally causes movement of the covering of the architectural-structure covering. To actuate movement of the rotatable member, and thus the covering of the architectural-structure covering, an operating system may be operably coupled to the rotatable member.

Referring to FIGS. 1 and 2, one well-known type of architectural-structure covering 100 is illustrated. As illustrated, the architectural-structure covering 100 may be in the form of a Roman shade. As illustrated, the architectural-structure covering 100 may include a head rail 102, a bottom rail 104, and a covering 106. The covering 106 extending between the head rail 102 and the bottom rail 104. In use, the covering 106 is arranged and configured to gather or stack adjacent to the head rail 102 in the retracted position.

As constructed, the covering 106 includes a rear layer or sheet 108 and a front layer or sheet 110 (terms layer and sheet are used interchangeably herein without the intent to limit). The rear layer 108 may be attached along an upper edge to the head rail 102 and attached along a lower edge to the bottom rail 104, which may function as a ballast to maintain the rear layer 108 in a taut condition. A length dimension of the rear layer 108 may extend from the head rail 102 to the bottom rail 104 in a direction generally orthogonal to the head rail 102 and the bottom rail 104. A width dimension of the rear layer 108 may extend from one side of the rear layer to an opposing side of the rear layer in a direction generally parallel to the head rail 102 and the bottom rail 104.

The front layer 110 may be attached to a front or first surface, face, side, etc. 111 (terms used interchangeably herein without the intent to limit) of the rear layer 108 along lines of attachment 112, which may extend along the width dimension of the rear layer 108. The lines of attachment 112 may be vertically-separated from, and generally parallel to, one another. The length of the front layer 110 defined between subsequent lines of attachment 112 may be longer than the length of the rear layer 108 defined between the same subsequent lines of attachment 112 so that the front layer 110 forms droops or loops of material 114 that extend widthwise across the front surface 111 of the rear layer 108. The loops of material 114 may extend forwardly and downwardly from the lines of attachment 112 and may define a vertical column or stack of horizontally-extending cells 116 between the rear and front layers 108, 110. The loops of material 114 may provide a uniform, cascading appearance and may overlap one another. The loops of material 114 may have a tear-drop shaped profile. The rear and front layers 108, 110 may be constructed of continuous lengths of material or may be constructed of strips of material attached or joined together in an edge-to-edge, overlapping, or other suitable relationship.

Referring to FIG. 2, to retract the covering 106 from the fully-extended position of FIG. 1 to the partially-retracted position of FIG. 2, the architectural-structure covering 100 may include a plurality of lift elements 118, such as lift cords, lift straps, or any other suitable lift element or mechanism. The lift elements 118 may be operatively coupled to the head rail 102 and the bottom rail 104 to raise the bottom rail 104 toward the head rail 102. A lower end of the lift elements 118 may be attached to the bottom rail 104, and an upper end of the lift elements 118 may be operatively coupled to an operating system to change the effective length of the lift elements 118 extending between the head rail 102 and the bottom rail 104. Example operating systems may include an electrical motor, a spring, an operating element 120 (such as a cord or ball chain) coupled to a spool, or any other suitable drive element or mechanism.

In use, the lift elements 118 may extend downwardly from the head rail 102 in a slidable path defined between the rear and front layers 108, 110 of the covering 106. In one embodiment, the front layer 110 may be secured intermittently to the rear layer 108 along the horizontal lines of attachment 112 to define vertically-aligned gaps between the rear and front layers 108, 110 through which the lift elements 118 may slide. During extension of the covering 106, the lift elements 118 may slide downwardly through the gaps relative to the rear and front layers 108, 110 to lower the bottom rail 104 away from the head rail 102. During retraction of the covering 106, the lift elements 118 may slide upwardly through the gaps relative to the rear and front layers 108, 110 to raise the bottom rail 104 toward the head rail 102.

Referring to FIG. 2, the rear and front layers 108, 110 may be gathered on the bottom rail 104 in opposing directions during retraction of the covering 106. The rear layer 108 may be gathered on the bottom rail 104 in a rearwardly direction and the front layer 110 may be gathered on the bottom rail 104 in a forwardly direction. The front layer 110 of the covering 106 may form forwardly-directed droops or loops of material 114 and define a vertical column or stack of horizontally-extending cells 116. The rear layer 108 of the covering 106 may form rearwardly-directed droops or loops of material 123.

One disadvantage of such a construction is that the lift elements 118 may be accessible via the horizontally-extending cells 116. It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a covering for use with an architectural-structure covering. In use, the covering is arranged and configured to be moved between an extended position and a retracted position. In one embodiment, the covering is in the form of a Roman shade, although other types of coverings are envisioned.

In one embodiment, the covering includes a front layer, a rear layer, and an intermediate barrier layer positioned between the front and rear layers. That is, for example, in one embodiment, the front layer includes a front or first side (e.g., a decorative side) and a rear or second side opposite the front or first side of the front layer. The rear layer includes a front or first side and a rear or second side opposite the front or first side of the rear layer. The intermediate barrier layer includes a front or first side and a rear or second side opposite the front or first side of the intermediate barrier layer. The rear or second side of the front layer is coupled to the front or first side of the intermediate barrier layer. The rear or second side of the intermediate barrier layer is coupled to the front or first side of the rear layer. A plurality of lift elements positioned between the rear or second side of the intermediate barrier layer and the front or first side of the rear layer. Thus arranged, the lift elements are rendered inaccessible, or at least access to the lift elements is severely limited, to an end user.

In one embodiment, the architectural-structure covering may also include a head rail, the head rail being operatively coupled to the covering such as, for example, the rear layer and/or the intermediate barrier layer.

In one embodiment, the architectural-structure covering may also include a bottom rail, the bottom rail being operatively coupled to the covering such as, for example, the plurality of lift elements and/or the front, rear, and/or intermediate barrier layers.

In one embodiment, the architectural-structure covering may also include a rotatable member operatively coupled to the lift elements so that rotation of the rotatable member causes the lift elements to wind and unwind about the rotatable member causing the covering to move between the extended and retracted positions.

In one embodiment, the intermediate barrier layer includes a width and a length, the width and the length of the intermediate barrier layer being equal to a width and a length of the rear layer.

In one embodiment, the intermediate barrier layer is bonded to the rear layer and/or the front layer.

In one embodiment, the lift elements are positioned (e.g., fed) between the intermediate barrier layer and the rear layer after the intermediate barrier layer is coupled to the rear layer.

In one embodiment, a method of manufacturing an architectural-structure covering is disclosed. In one embodiment, the method includes coupling a rear side of an intermediate barrier layer to a front side of a rear layer, coupling a rear side of a front layer to a front side of the intermediate barrier layer, and positioning a plurality of lift elements between the rear side of the intermediate barrier layer and the front side of the rear layer.

In one embodiment, coupling a rear side of an intermediate barrier layer to a front side of a rear layer includes bonding the rear side of the intermediate barrier layer to the front side of the rear layer.

In one embodiment, coupling a rear side of a front layer to a front side of the intermediate barrier layer includes bonding the rear side of the front layer to a front side of the intermediate barrier layer.

In one embodiment, positioning a plurality of lift elements between the rear side of the intermediate barrier layer and the front side of the rear layer includes feeding the plurality of lift elements between the rear side of the intermediate barrier layer and the front side of the rear layer after the rear side of the intermediate barrier layer is coupled to the front side of the rear layer.

### BRIEF DESCRIPTION OF THE DRAWINGS

FIG. 1 is a front perspective view of a known example embodiment of an architectural-structure covering for an architectural opening in a fully-extended position;

FIG. 2 is a rear perspective view of the architectural-structure covering of FIG. 1 showing the covering in a partially-retracted position;

FIG. 3 is a rear perspective view of an example of an embodiment of a covering in accordance with features of the present disclosure;

FIG. 4A is a front perspective view of an example of an embodiment of a covering in accordance with features of the present disclosure, the covering illustrated in a fully extended position; and

FIG. 4B is a front perspective view of the covering of FIG. 4A illustrated in a partially retracted position.

### DETAILED DESCRIPTION

Embodiments of a covering in accordance with the present disclosure will now be described more fully hereinafter with reference to the accompanying drawings, in which preferred embodiments of the present disclosure are presented. The covering of the present disclosure may, however, be embodied in many different forms and should not be construed as being limited to the embodiments set forth herein. Rather, these embodiments are provided so that this disclosure will convey certain example features of the covering to those skilled in the art. In the drawings, like numbers refer to like elements throughout unless otherwise noted.

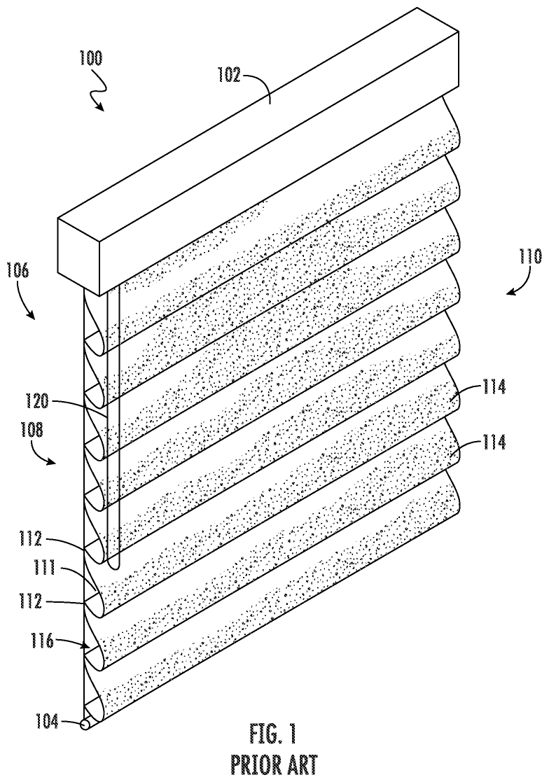

As will be described and illustrated herein, the covering may include an intermediate sheet, a barrier layer, a shroud, or any other suitable layer, fabric, or the like (terms used interchangeably herein without the intent to limit). In use, the intermediate barrier layer may be positioned between a front layer such as, for example, a front decorative layer such as front layer 110 of FIG. 1 and a rear layer such as, for example, a rear support sheet such as rear layer 108 of FIG. 1. Lift elements such as, for example, lift elements 118 of FIG. 1 may be positioned between the intermediate barrier layer and the rear layer. Thus arranged, the lift elements may be positioned between the intermediate barrier layer and the rear layer. As such, the lift elements are rendered inaccessible, or at least access to the lift elements is severely limited or prevented, through the openings or cells defined by the front layer.

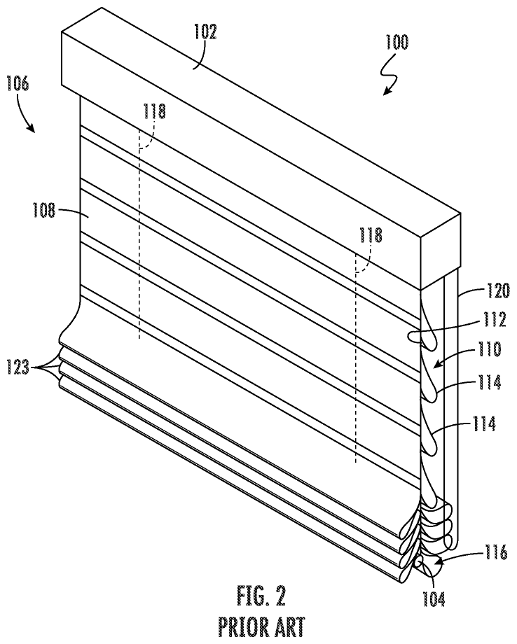

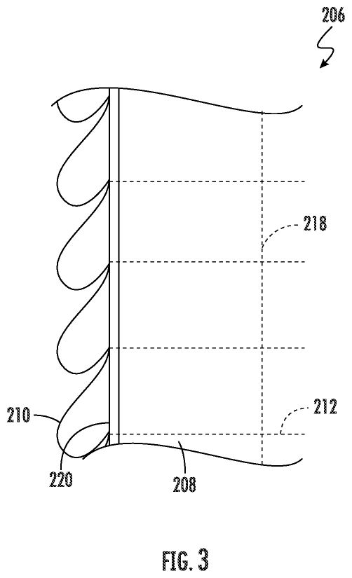

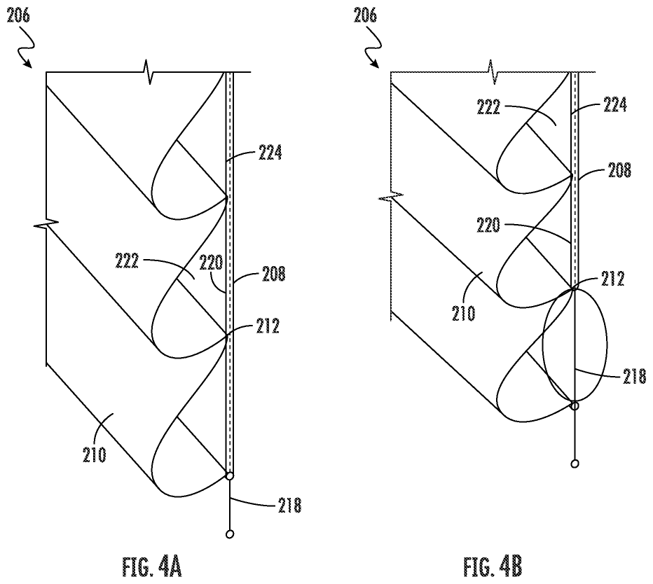

Referring now to FIGS. 3, 4A and 4B, a covering 206 according to an example embodiment of the present disclosure will now be described. In use, the covering 206 of the present disclosure may be used in connection with an architectural-structure covering, for example, a Roman shade as previously shown and described in connection with FIGS. 1 and 2. However, it should be appreciated that the principles of the present disclosure have application and use with other coverings and architectural-structure coverings thus the present disclosure should not be limited to any particular type of covering or architectural-structure covering unless explicitly claimed.

As shown, in accordance with an illustrative, non-limiting embodiment of the present disclosure, the covering 206 includes a rear layer 208, a front layer 210, and an intermediate barrier layer 220. In use, as previously described, the rear layer 208 may be attached along an upper edge to, or operatively associated with, a head rail and attached along a lower edge to, or operatively associated with, a bottom rail. The covering 206 is arranged and configured to gather or stack in the retracted position. In addition, the architectural-structure covering 200 includes a plurality of lift elements 218, such as lift cords, lift straps, or any other suitable lift element or mechanism. In use, as previously mentioned, the lift elements 218 may be operatively coupled to, or associated with, the head rail and the bottom rail to raise the bottom rail toward the head rail, and thus to retract the covering 206 (e.g., a lower end of the lift elements 218 may be attached to the bottom rail and an upper end of the lift elements 218 may be operatively coupled to a rotatable member associated with an operating system to change the effective length of the lift elements 218 extending between the head rail and the bottom rail).

In accordance with one or more features or principles of the present disclosure, the lift elements 218 may extend downwardly from the head rail to the bottom rail between the rear and intermediate barrier layers 208, 220 of the covering 206. In this manner, access to the lift elements 218 is inhibited.

In one embodiment, the intermediate barrier layer 220 may include a front side 222 and a rear side 224. The front layer 210 may be secured to the front side 222 of the intermediate barrier layer 220 such as, for example, intermittently along horizontal lines of attachment 212. The rear layer 208 may be secured to the rear side 224 of the intermediate barrier layer 220. The rear layer 208 may be secured to the rear side 224 of the intermediate barrier layer 220 either continuously along a length thereof or intermittently such as, for example, intermittently along horizontal lines of attachment 212. In either case, in one embodiment, the front layer 210 and the rear layer 208 may be bonded to the intermediate barrier layer 220, although other mechanisms for coupling the intermediate barrier layer 220 to the front and rear layers 210, 208 are envisioned.

In one embodiment, the intermediate barrier layer 220 may include a width and length substantially equal to the width and length of the rear layer 208. In this manner, the intermediate barrier layer 220 may be processed, assembled, etc. to be coplanar with the rear layer 208. That is, during manufacturing, the intermediate barrier layer 220 may be coupled or bonded to the rear layer 208. Subsequently, the lift elements 218 may be fed in-between the intermediate and rear layers 220, 208. Alternatively, however, it is envisioned that the intermediate barrier layer may have other sizes and configurations such as, for example, the intermediate barrier layer may be manufactured from a plurality of layers with each layer having a width less than the width of the rear layer but wide enough to sandwich the lift elements. Subsequently, the front layer 210 can be coupled to the intermediate barrier layer 220 and the architectural-structure covering can be assembled including coupling the bottom rail, rotatable member, etc. In addition, by providing the intermediate barrier layer 220 with a width and length substantially equal to the width and length of the rear layer 208, the size and shape of the intermediate barrier layer 220 is equal to the rear layer 208 thereby providing an improved aesthetical appearance (e.g., eliminates any identifiable cell or gap between the intermediate barrier layer 220 and the rear layer 208).

As will be appreciated by one of ordinary skill in the art, incorporating an intermediate barrier layer 220 (e.g., by coupling an intermediate barrier layer 220 to the rear layer 208 and subsequently feeding the lift elements 218 between the intermediate and rear layers 220, 208, makes the lift elements 218 inaccessible, or at least greatly limiting accessibility, to users. At the same time, the assembling process remains substantially identical to current practices except for the step of bonding the intermediate barrier layer to the rear layer.

The foregoing description has broad application. For example, the principles of employing an intermediate barrier layer to render lift elements inaccessible, or at least greatly limiting accessibility, to end users may be used with any type of architectural-structure covering, including, but not limited to, roller and stackable shades. Accordingly, the discussion of any embodiment is meant only to be explanatory and is not intended to suggest that the scope of the disclosure, including the claims, is limited to these examples. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more embodiments or configurations for the purpose of streamlining the disclosure. However, it should be understood that various features of the embodiments or configurations of the disclosure may be combined in alternate embodiments or configurations. Moreover, the following claims are hereby incorporated into this Detailed Description by this reference, with each claim standing on its own as a separate embodiment of the present disclosure.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority but are used to distinguish one feature from another. The drawings are for purposes of illustration only and the dimensions, positions, order, and relative sizes reflected in the drawings attached hereto may vary.

1. An architectural-structure covering comprising:
a covering moveable between an extended position and a retracted position, the covering including:
a front layer having a first decorative side and a second side opposite the first decorative side;
a rear layer having a first side and a second side opposite the first side of the rear layer;
an intermediate barrier layer having a first side and a second side opposite the first side of the intermediate barrier layer;
wherein:
the second side of the front layer is coupled to the first side of the intermediate barrier layer and the second side of the intermediate barrier layer is coupled to the first side of the rear layer; and
a plurality of lift elements positioned between the second side of the intermediate barrier layer and the first side of the rear layer.

2. The architectural-structure covering of claim 1, further comprising a head rail, wherein the rear layer is coupled the head rail.

3. The architectural-structure covering of claim 2, further comprising a bottom rail, wherein the rear layer is coupled to the bottom rail.

4. The architectural-structure covering of claim 3, further comprising a rotatable member, the plurality of lift elements being operatively coupled to the rotatable member and to the bottom rail so that rotation of the rotatable member causes the plurality of lift elements to wind and unwind about the rotatable member causing the covering to move between the extended and retracted positions.

5. The architectural-structure covering of claim 1, wherein the intermediate barrier layer includes a width and a length, the width and the length of the intermediate barrier layer being equal to a width and a length of the rear layer.

6. The architectural-structure covering of claim 1, wherein the second side of the intermediate barrier layer is bonded to the first side of the rear layer.

7. The architectural-structure covering of claim 6, wherein the second side of the front layer is bonded to the first side of the intermediate barrier layer.

8. The architectural-structure covering of claim 1, wherein the plurality of lift elements are fed between the second side of the intermediate barrier layer and the first side of the rear layer after the second side of the intermediate barrier layer is coupled to the first side of the rear layer.

9. A method of manufacturing an architectural-structure covering, the method comprising:
coupling a rear side of an intermediate barrier layer to a front side of a rear layer;
coupling a rear side of a front layer to a front side of the intermediate barrier layer; and
positioning a plurality of lift elements between the rear side of the intermediate barrier layer and the front side of the rear layer.

10. The method of claim 9, wherein coupling a rear side of an intermediate barrier layer to a front side of a rear layer comprises bonding the rear side of the intermediate barrier layer to the front side of the rear layer.

11. The method of claim 10, wherein coupling a rear side of a front layer to a front side of the intermediate barrier layer comprises bonding the rear side of the front layer to the front side of the intermediate barrier layer.

12. The method of claim 9, further comprising operatively coupling an upper end of the plurality of lift elements to a rotatable member and a bottom end of the plurality of lift elements to a bottom rail.

13. The method of claim 9, wherein positioning a plurality of lift elements between the rear side of the intermediate barrier layer and the front side of the rear layer comprises feeding the plurality of lift elements between the rear side of the intermediate barrier layer and the front side of the rear layer after the rear side of the intermediate barrier layer is coupled to the front side of the rear layer.

14. An architectural-structure covering comprising:
a rotatable member; and
a covering operatively coupled to the rotatable member, the covering being moveable between an extended position and a retracted position, the covering including:
a front layer having a first side and a second side opposite the first side;
a rear layer having a first side and a second side opposite the first side of the rear layer;
an intermediate barrier layer having a first side and a second side opposite the first side of the intermediate barrier layer;
wherein:
the second side of the front layer is coupled to the first side of the intermediate barrier layer and the second side of the intermediate barrier layer is coupled to the first side of the rear layer; and
a plurality of lift elements operatively coupled to the rotatable member, the plurality of lift elements being positioned between the second side of the intermediate barrier layer and the first side of the rear layer.

15. The architectural-structure covering of claim 14, wherein the intermediate barrier layer includes a width and a length, the width and the length of the intermediate barrier layer being equal to a width and a length of the rear layer.

16. The architectural-structure covering of claim 14, wherein the second side of the intermediate barrier layer is bonded to the first side of the rear layer.

17. The architectural-structure covering of claim 16, wherein the second side of the front layer is bonded to the first side of the intermediate barrier layer.

18. The architectural-structure covering of claim 14, wherein the plurality of lift elements are fed between the second side of the intermediate barrier layer and the first side of the rear layer after the second side of the intermediate barrier layer is coupled to the first side of the rear layer.
